(19) United States
(12) Patent Application Publication
(10) Pub. No.: US 2006/0265544 A1
(43) Pub. Date: Nov. 23, 2006

(54) Internally authenticated flash remediation

(76) Inventor: John Rudelic, Folsom, CA (US)

Correspondence Address: TROP PRUNER & HU, PC, 1616 S. VOSS ROAD, SUITE 750, HOUSTON, TX, 77057-2631, US

(21) Appl. No.: 11/130,759

(22) Filed: May 17, 2005

(51) Int. Cl. G06F 12/00

(52) U.S. Cl. 711/103

(57) ABSTRACT

Remediation code may be stored in an area of a flash memory which is inaccessible to normal write commands. When a command is received that is directed to a block of a flash array which has a certain bit set, that block can be recognized as one which relates to the remediation code in one embodiment. In such case, the request may be coalesced with other requests in a remediation memory. When sufficient number of such operations have been coalesced, they may be authenticated in some embodiments.

### BACKGROUND

This invention relates generally to flash memory devices.

Flash memory is a type of semiconductor memory which can be reprogrammable. Some flash memories include not only a flash memory array, but also a controller and a randomly accessible memory separate from the flash array.

Remediation is the ability to scan code objects outside where those code objects are being executed to look for common exploits. For example, viruses may attack computer systems. Virus scanning may be used to attempt to identify exploits indicative of virus scanning. Thus, remediation may be used in connection with virus scanning to look through the binary code for pointer increments that go past the size of the object pointed to. In many cases the remediation is done as part of the protection of the computer system, for example, from virus scanning. However, the possibility exists that the remediation code may be altered by an unscrupulous accessor.

Thus, there is a need for other ways to implement remediation.

### BRIEF DESCRIPTION OF THE DRAWINGS

FIG. 1 is a schematic depiction of a flash memory in accordance with one embodiment of the present invention;

FIG. 2 is a flow chart for remediation software in accordance with one embodiment of the present invention; and

FIG. 3 is a system depiction for one embodiment of the present invention.

### DETAILED DESCRIPTION

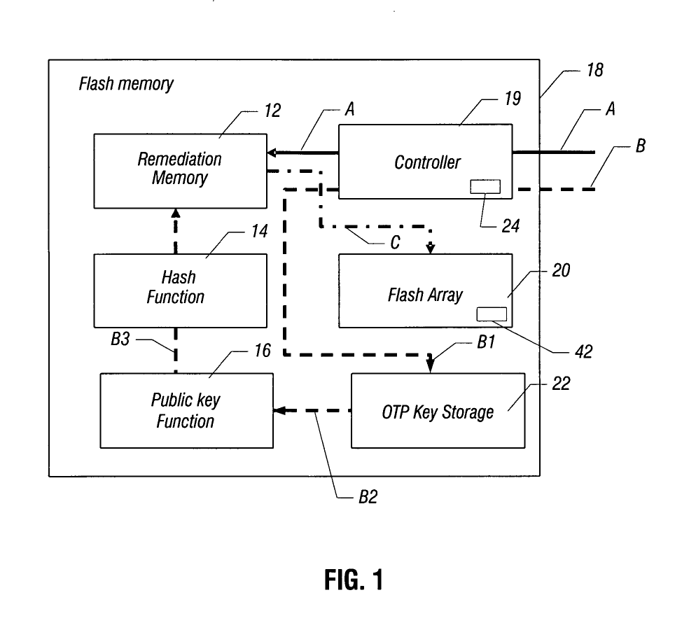

Referring to FIG. 1, a flash memory 18 may be any flash memory that includes a controller such as the controller 19. For example, the flash memory 18 may be a NOR flash memory which typically includes a controller, but may also be a NAND flash memory that includes a controller, although controllers are not normally included in NAND flash memory.

The controller 19 may be any controller including a microcontroller or a processor that runs general purpose commands. The controller 19 may store software 24 that handles remediation.

The controller 19 may be coupled by signal path A to a remediation memory 12. The remediation memory 12 may be a separate memory, such as a random access memory, accessible to the controller 19. In another embodiment, the remediation memory 12 may simply be a portion of the flash array 20. The flash array 20 is simply the array of flash memory cells that store information in the flash memory 18. Normally, the controller 19 communicates with the flash array 20, although no such connection is shown in FIG. 1 for purposes of simplification. However, a signal path C is shown from the remediation memory 12 to the flash array 20.

The flash array 20 may include memory locations 42 that store authentication bits. The memory locations 42 may store the authentication bits to enable the system to determine whether a particular write or read access is one which must be handled in a different way than normal write and read accesses. In other embodiments, the bits may be stored in memory other than the flash array 20.

Also coupled to the controller 19 via a path B1 is a one-time programmable (OTP) key storage 22. In other embodiments, other storage such as a conventional flash memory cell may be used. While the key storage 22 is indicated to be a separate memory, it too may be part of the flash array 20 in some embodiments. The key storage 22 stores a key that is used for public key authentication. Thus, the key storage 22 communicates, via a path B2, with the public key function 16. The public key function 16 may be any authentication function, including one which operates under the RSA algorithm, invented in 1978 by Ron Rivest, Adi Shamir, and Leonard Adlemen, a symmetric key, or a password, to mention a few examples.

RSA is a cryptographic algorithm that offers a high level of security for digital data transfers. RSA uses a public key and a private key and incorporates modular exponentiation mathematics. Modular exponentiation of large integers may be efficiently computed within the public key function 16 by repeated modular multiplications. Pipelining techniques or repetitive multiplication cycles may be used for the massive parallel computations.

Coupled to the public key function 16 is a hash function 14. In one embodiment, the hash function 14 may be a secure hash algorithm (SHA or SHA-1). The SHA algorithm takes a given bit stream message and produces a unique 160 bit message digest. The SHA algorithm is specified in the secure hash standard (SHS, FIPS 180), with the SHA-1 algorithm being a revision to SHA that was published in 1994. In accordance with some embodiments of the present invention, the blocks 14 and 16 execute instructions and process data to accommodate applications that include message digest algorithms, hash functions, public/private keys, digital signatures, and/or authorization certificates.

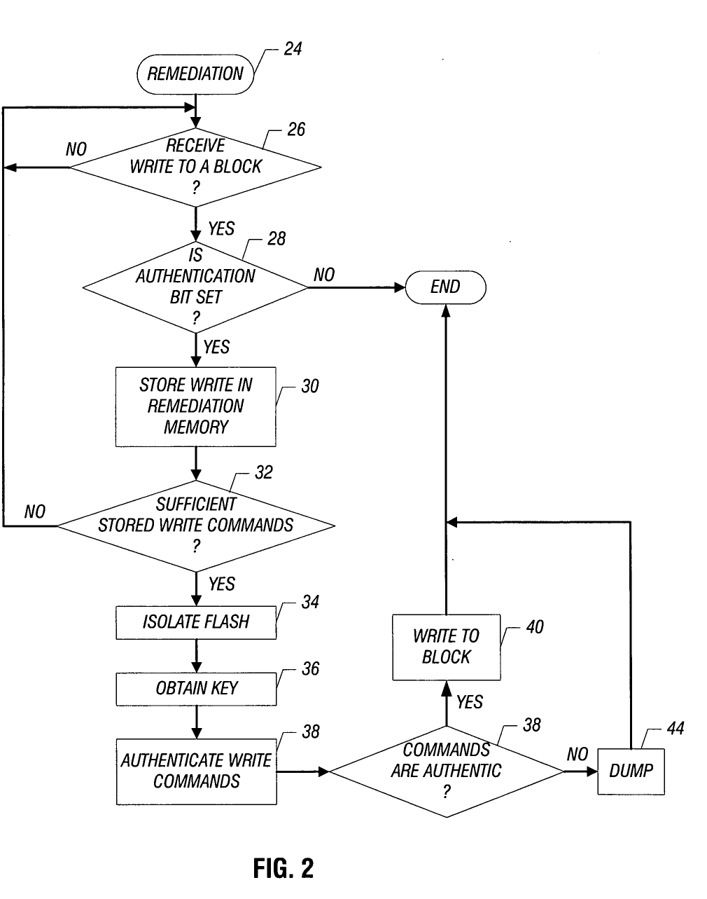

Referring to FIG. 2, the operation of the remediation software 24, in a secure fashion, begins by receiving a write to a block, presumably, within the flash array 20 as indicated in diamond 26. Each block in the flash array may have an authentication bit stored in the flash array 22 at locations 42 or somewhere else. A determination is made at diamond 28 whether the authentication bit is set for the block which is the target of the received write transaction. If so, the write is stored in the remediation memory 12 as indicated in block 30 in FIG. 2 (and arrow A in FIG. 1). Effectively, the write is buffered in the remediation memory 12 for a period of time.

A check at diamond 32, in one embodiment, determines whether sufficient stored write commands have been buffered in the remediation memory 12. The buffering of a series of write commands to be authenticated may make the operation of the system more efficient so that a series of a given number of buffered write commands may all be handled sequentially. In one embodiment, if sufficient stored write commands are now buffered in the remediation memory 12, the flash memory 18 may be isolated (block 34) from the rest of the processor-based system (not shown in FIG. 1 or 2). Once isolated, a key is obtained from the write command as indicated in block 36. The key may come from a number of outside sources. For example, in connection with cellular telephone applications, the key may be owned by a service provider or by the platform provider.

The key 36 is then authenticated by the public key function 16 and the hash function 14 which obtain the public key from the one-time programmable key storage 22. Using all of this information, the write command is authenticated in block 38. If the command is authentic, meaning that it is a legitimate remediation command and not an attempt by an unauthorized person to intervene in the remediation process, as determined in diamond 38, the write is allowed to the block as indicated in block 40. Thereafter, the flow ends. If the commands are not authentic, they may be dumped as indicated in block 44.

When a write comes into a block without its authentication bit set, the writes are stored and handled in the conventional fashion. Only the writes to the remediation memory 12 undergo the authentication process, enabling the authentication process to be used judiciously. The remediation memory 12 may also be used to store and coalesce any writes that need authentication in addition to remediation writes.

Thus, in some embodiments, remediation is executed internally to the flash memory 18 after the remediation code has passed authentication. In this way, the remediation code will have unmitigated access to the flash memory 18. The remediation software 24 also can scan the boot block, the blocks that contain the operating system and the file system blocks as necessary. Another advantage, in some embodiments, is that the remediation code is hidden from the normal flash array. The remediation code is stored in a hidden, inaccessible memory location. The remediation code can be configured to execute on boot, on power down, and on demand as remediation code is loaded into the hidden internal execution memory. The remediation code may be unmodifiable without passing the internal authentication mechanisms.

Thus, there are at least three situations where remediation code may be handled. The first involves the installation of remediation code. In this scenario, the remediation code is installed into the remediation memory 12 with a special flash write command as indicated by path A in FIG. 1. The remediation memory 12 is secure and hidden internal execution memory. The remediation memory 12 holds the remediation code for execution. The controller 19 executes the remediation code from the remediation memory, as indicated by the path C, in FIG. 1.

A second scenario involves the authentication of the remediation code. In this scenario, remediation code that has been installed in the remediation memory 12, as described above, is authenticated. The remediation code will also contain the signature of an authentication agency. The signature of the remediation code may be authenticated by the hash function 14 and the public key function 16, using a public key installed in the one-time programmable key storage 22. If the remediation code passes authentication, then the remediation code is allowed to run.

The third scenario is execution of the remediation code. In this scenario, the remediation code is executed by the controller 19 to perform the remediation actions prescribed by the remediation code. The remediation code can be executed a single time on authenticated installation, on every boot, or on every power down, to mention a few examples.

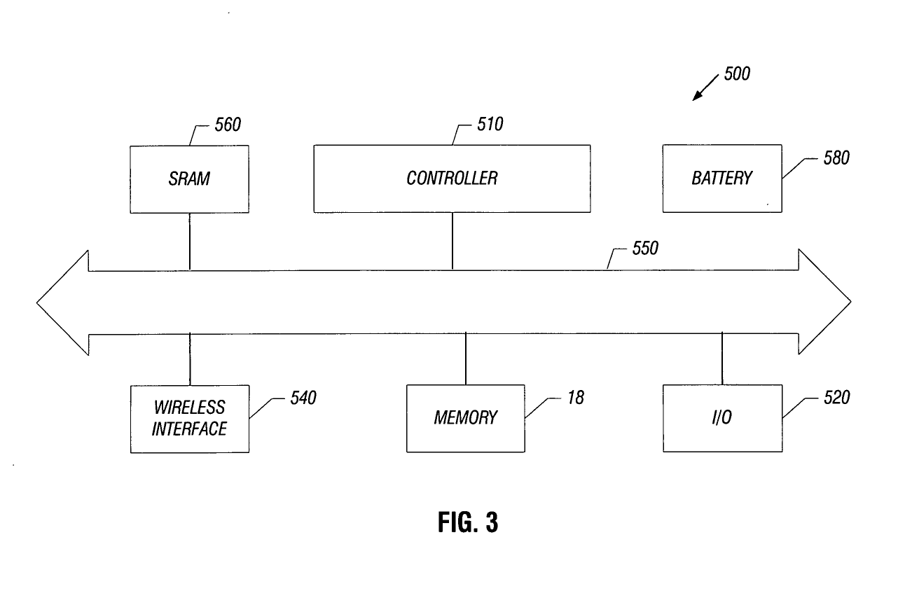

Referring to FIG. 3, a system 500 may be any processor-based system including a wired or wireless system. It may be a system which is involved in wireless communications such as a cellular telephone. A controller 510 may be a microcontroller, one or more microprocessors, or a digital signal processor, to mention a few examples. In one embodiment, the system may be battery powered as indicated at 580, but in other embodiments, the system 500 may be hard wired to a line power.

The controller 510 is coupled to a bus 550, which also couples to a static random access memory 560 in one embodiment. Also coupled to the bus 550 may be a wireless interface 540. The wireless interface may include, for example, a dipole antenna and may be used in embodiments that implement wireless communications. Also coupled to the bus 550 is an input/output device 520, such as a display, a keyboard, or a mouse, to mention a few examples.

Finally, the memory 18 may be coupled to the bus 550. Thus, the memory 18 may be isolated from the rest of the device during the operation of the remediation code. This enables the device to implement authentication in a way which cannot be interfered with by outside sources.

The system 500 may be any of a variety of processor-based systems, including desktop computers, laptops, cellular telephones, digital media players, cameras, communications devices, personal digital assistants, set top boxes, medical equipment, or automotive equipment, to mention a few examples. The architecture shown in FIG. 3 is not meant to be limiting and the present invention is adapted to any conceivable system architecture.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
executing remediation code within a semiconductor memory.

2. The method of claim 1 including authenticating said remediation code before executing said remediation code.

3. The method of claim 2 including authenticating said remediation code within said semiconductor memory.

4. The method of claim 2 including sending remediation code from a system to a semiconductor memory coupled to said system and executing said code.

5. The method of claim 4 including isolating said semiconductor memory from said system while authenticating a write command in said memory.

6. The method of claim 2 including executing said code in a controller within said memory.

7. The method of claim 3 including authenticating said code from a one time programmable storage.

8. The method of claim 3 including checking stored data to determine whether or not to authenticate a write command.

9. The method of claim 8 including storing write commands to be authenticated in a storage medium.

10. The method of claim 9 including authenticating at least two write commands stored in said storage medium.

11. An article comprising a medium storing instructions that, if executed, enable a processor-based system to:
execute remediation code within a semiconductor memory.

12. The article of claim 11 further storing instructions that, if executed, enable the system to authenticate said remediation code before executing said remediation code.

13. The article of claim 12 further storing instructions that, if executed, enable the system to authenticate said remediation code within said semiconductor memory.

14. The article of claim 12 further storing instructions that, if executed, enable said code to be executed in a controller within said memory.

15. The article of claim 13 further storing instructions that, if executed, enable the system to authenticate said code from a one time programmable memory.

16. The article of claim 13 further storing instructions that, if executed, enable the system to check a storage to determine whether or not to authenticate a write command.

17. The article of claim 16 further storing instructions that, if executed, enable the system to store write commands to be authenticated in a storage medium.

18. The article of claim 17 further storing instructions that, if executed, enable the system to authenticate at least two write commands stored in said storage medium.

19. A semiconductor memory comprising:
a memory array; and
a controller, said controller to execute remediation code within said semiconductor memory.

20. The memory of claim 19, said controller to authenticate said remediation code before executing said remediation code.

21. The memory of claim 20, said controller to authenticate said remediation code within said semiconductor memory.

22. The memory of claim 20, said controller to receive remediation code and to execute said code.

23. The memory of claim 22 wherein said controller to isolate said semiconductor memory while authenticating a write command in said memory.

24. The memory of claim 19 wherein said memory is a flash memory.

25. A system comprising:
a processor;
a semiconductor memory coupled to said processor, said semiconductor memory including a controller to execute remediation code within said semiconductor memory; and
a wireless interface coupled to said processor.

26. The system of claim 25 wherein said memory is a flash memory.

27. The system of claim 25 wherein said wireless interface includes a dipole antenna.

28. The system of claim 25 wherein said memory to isolate itself from the rest of said system while authenticating a write command.

29. The system of claim 25, said controller to authenticate said remediation code before executing said remediation code.

30. The system of claim 26, said controller to authenticate said remediation code within said semiconductor memory.
